(19) United States
(12) Patent Application Publication
(10) Pub. No.: US 2011/0057754 A1
(43) Pub. Date: Mar. 10, 2011

(54) METHODS & SYSTEMS FOR GENERATING A GRAVITY-NEUTRAL REGION BETWEEN TWO COUNTER-ROTATING MAGNETIC SOURCES, IN ACCORDANCE WITH ECE THEORY

(75) Inventor: Charles W. KELLUM, Alexandria, VA (US)

(73) Assignee: GALACTICAN GROUP, Alexandria, VA (US)

(21) Appl. No.: 12/879,954

(22) Filed: Sep. 10, 2010

Related U.S. Application Data
(60) Provisional application No. 61/241,249, filed on Sep. 10, 2009.

(51) Int. Cl. H01F 13/00; H01F 7/02

(52) U.S. Cl. 335/284; 335/306

(57) ABSTRACT

Methods and systems for creating a local anti-gravity region are defined. The anti-gravity region is created between two counter-rotating magnetic sources. The magnetic sources can be permanent magnets, magnetized material, or a combination of both. Matter in the induced anti-gravity region obviously behaves as in a zero-gravity environment, such as outer space. Processes conducted in the anti-gravity region can experience increased efficiency. The anti-gravity effect is generated by the electromagnetic fields, of the counter-rotating magnetic sources, resonating with the torsion of spacetime. This resonance causes the potential of the electromagnetic fields to be amplified, in accordance with the new ECE (Einstein-Cartan-Evans)-Theory of physics. ECE-Theory shows gravitation and electromagnetism are both defined as manifestations of the curvature of spacetime.

### 1. BACKGROUND OF THE INVENTION

### Field of the Invention

This invention relates to methods and systems for generating an anti-gravity region between magnetic sources. Electromagnetic forces are created, configured, and aligned so as to generate an anti-gravity effect.

Such an anti-gravity effect is caused by the change in curvature of spacetime. Gravitation is the curvature of spacetime. Electromagnetism is the spinning (or torsion) of spacetime. By properly amplifying the interaction between these forces, anti-gravity effects can be produced. Obviously, the magnetic sources can be viewed as magnetized matter. Their interaction is used to induce spacetime curvature, thus creating an anti-gravity effect. This process can have applications ranging from electric power generation, to vehicular propulsion. A primary application of the invention is demonstration of Einstein-Cartan-Evans (ECE)-Theory principles. ECE-Theory principles include anti-gravitation via interaction between forces.

### 1.1 INTRODUCTION

Electromagnetic radiation is the basis by which we perceive and measure phenomena. All of our human experiences and observations rely on electromagnetic radiation. Observing experiments and phenomena perturb electromagnetic radiation. Our observations and measurements sense the resulting perturbations in electromagnetic fields. This realization has far reaching ramifications, ranging from our basic perceptions of the universe, to our concepts of space, time, and reality.

As a starting point, the Special Theory of Relativity postulates that the speed-of-light (c), is the maximum velocity achievable in our spacetime continuum. A more correct statement, of this result of Einstein's ingenious theory, is that c is the greatest observable velocity (i.e. the maximum velocity that can be observed) in our spacetime. This is because c (the natural propagation speed of electromagnetic radiation) is our basis of observation. Phenomena moving at speeds≧c cannot be normally observed using electromagnetic radiation. Objects/matter moving at trans-light or super-light velocities will appear distorted or be unobservable, respectively. A brief analytical discussion of these factors is given below, in following sections. This is the first, of the two primary principles, exploited in this document.

The second principle is that electromagnetism and gravitation are both expressions of spacetime curvature. Stated from the analytical perspective, electromagnetism and gravitation are respectively the antisymmetric and symmetric parts of the gravitational Ricci Tensor. Since both the electromagnetic field and the gravitational field are obtained from the Riemann Curvature Tensor, both fields can be viewed as manifestations/expressions of spacetime curvature. This principle is proven in several works, some of which are listed in section 1.1.1, below.

### 1.1.1 Applicable Documents

[1] “Gravitation and Cosmology”
   Principles & Applications of the General Theory of Relativity

By: Steven Weinberg, MIT

John Wiley & Sons, Inc, 1972
[2] “Gravitation”

By: C. Misner, K. Thorne, J. Wheeler

W. H. Freeman & Co., 1973
[3] “Why There is Nothing Rather Than Something”
   (A Theory of the Cosmological Constant)

By: Sidney Coleman

Harvard University, 1988
[4] “Superstring Theory”
   Vols. 1 & 2

By: M. Green, J. Schwarz, E. Witten

Cambridge University Press, 1987
[5] “Chronology Protection Conjecture”

By: Steven W. Hawking

University of Cambridge, UK 1992
[6] “The Enigmatic Photon”
   Vol. 1: The Field B⁽³⁾
   Vol. 2: Non-Abelion Electrodynamics
   Vol. 3: Theory & Practice of the B⁽³⁾ Field

By: M. Evans, J. Vigier

Kluwer Academic Publishers, 1994-1996
[7] “The B⁽³⁾ Field as a Link Between Gravitation & Electromagnetism in the Vacuum”

By: M. Evans

York University, Canada 1996
[8] “String Theory Dynamics in Various Dimensions”

By: Edward Witten

Institute for Adv. Study; Princeton, N.J. 1995
[9] “Can the Universe Create Itself?”

By: J. Richard Gott III, Li-Xin Li

Princeton University, 1998
[10] “Superconducting Levitation”

By: F. Moon

John Wiley & Sons, Inc, 1994
[11] “The Levitron™: An Adiabatic Trap for Spins”

By: M. V. Berry

Wills Physics Laboratory, Bristol BS8 1TL, UK
[12] Spinner toy example
   (electric circuit defined by U.S. Pat. No. 3,783,550)

Andrews Mfg, Co., Inc. Eugene, Oreg.
[13] “Generally Covariant Unified Field Theory”

By; M. W. Evans

Abramis, Suffolk, (2005 onwards)
[14] “The Spinning and Curving of Spacetime; The Electromagnetic & Gravitational Field in the Evans Unified Field Theory”

By; M. W. Evans

AIAS 2005
[15] “Spacetime and Geometry; An Introduction to General Relativity”

By; Sean M. Carroll

Addison Wesley, 2004 ISBN 0-8053-8732-3
[16] “Spin Connected Resonances in Gravitational General Relativity”

By; M. W. Evans

Aeta. Phys. Pol. B, vol. 38, No. 6, June 2007

AIAS (UFT posting [64])
[17] “Spin Connected Resonance in Counter-Gravitation”

By; H. Eckardt, M. W. Evans

AIAS (UFT posting [68])
[18] “Devices for Space-Time Resonance Based on ECE-Theory”

By; H. Eckardt

AIAS posting 2008
[19] “ECE Engineering Model, version 2.4, 18 May 2009”

By; H. Eckardt

AIAS posting 2009
[20] “The Resonant Coulomb Law of ECE-Theory”

By; M. W. Evans, H. Eckardt

AIAS (UFT posting [63])
[21] “Theoretical Discussions of the Inverse Faraday Effect, Raman Scattering, and Related Phenomena”

By; P. Pershan, J. van der Ziel, L. Malmstrom (Harvard Univ.)

Physical Review vol. 143, No. 2, March 1965
[22] “Description of the Faraday Effect and Inverse Faraday Effect in Terms of the ECE Spin Field”

By; M. W. Evans

AIAS (UFT posting [81]) 2007
[23] “Curvature-Based Propulsion; Geodesic-Fall; The Levitron, An ECE-Theory Demonstration Device”

By; Charles Kellum

The Galactican Group; 17 Mar. 2009
[24] “Spin connection resonance in the Faraday disk generator”

By: M. W. Evans, H. Eckardt, F. Amador

AIAS (UFT posting [107], 2008
[25] “Curvature-based Propulsion Laboratory-Scale Demonstration Report”

By: C. Kellum;

The Galactican Group, USA June 2008

### 1.1.2 Overview

The above cited (and related) works also raise fundamental issues as to the origin, dynamics, and structure of our spacetime continuum. Our universe appears to be dynamic in several parameters. It is suggested that the results arrived at in this document might shed some small light on a few of said fundamental issues. Please note that boldface type indicates a vector quantity, in the remainder of this document; example (v implies the vector quantity [symbol] ).

The objective here is to describe/present a new method of, and system for, propulsion. This method is based on utilizing the equivalence of electromagnetism and gravity by inducing local spacetime curvature. The induced curvature results in a geodesic curve. The “propulsion phase” involves a “fall” along said geodesic curve. The basic definition for a geodesic is (in the context of gravitational physics), from [2]:
a curve that is straight and uniformly parameterized as measured in each local Lorentz frame (coordinate system at a point of the curve) along its way. (where a “curve” is a parameterized sequence of points)
as a general definition, a geodesic is a free-fall trajectory, which is the shortest path between two points, wherein said points are on some metric-space.

The process is called “geodesic-fall”. The “geodesic-fall vector” is denoted as [symbol] The “geodesic-fall” process requires the generation of a proper electromagnetic field to induce local spacetime curvature and, fall along the resulting geodesic curve. The vehicle/particle under “geodesic-fall” moves along the geodesic curve at a velocity dependant on the degree of induced curvature. Theoretically, the maximum achievable velocity is determined by curvature. The maximum achievable velocity is not limited by c (the speed-of-light) in normal/unperturbed spacetime. Under The “geodesic-fall” process, the primary constraints on velocity are due to the degree of induced curvature, and to the structure of the vehicle.

### 1.2 BASIC CONCEPTS

Trans-light and super-light speeds have long been the domain of the science fiction community. In recent years, serious cosmologists and theoreticians have examined this arena. Below is presented a generalized view of the Special Relativity Theory. One starts with a regional structure of spacetime.

### 1.2.1 Regions of Spacetime

It has been suggested (for example in [9], by some string-theorists, etc.) that the “Big Bang” was a local phenomena, and that other “Big Bang” type phenomena events might be observable in distant reaches of our known universe. Additionally, many of the theoretical problems with the “Big Bang theory” (primary among which is causality), can be solved by considering a regional structure of spacetime. The, depending on the size of the regions, a “Big Bang” event could be viewed as a local phenomenon.
Below in this document, an arbitrary region of spacetime is examined and equations-of-motion (based on a generalized parameter of said region) are derived, so as to develop a generalized view of Special Relativity.
   A regional view of spacetime can offer several analytical advantages and some ramifications. For this work, one can consider our known spacetime as a “region” of the universe. Under this framework, certain phenomena encountered by astrophysicists and cosmologists might be accounted for through boundary conditions of our spacetime region. Black holes, and the possible variance of c, are examples of such phenomena.

Further, if the “Big Bang” is a local phenomenon, this reality would suggest that the universe has always existed. Coupled with aspects of M-Theory, a regional structure of the universe makes it not unreasonable to consider the universe without a specific origin, as one contemplates the definition of origin in this context. It is possible that the universe has always existed. Additionally, observed background radiation could be accounted for as inter-regional energy exchange.

### 1.2.2 Velocity

To examine constraints on velocity, using geodesic-fall ( [symbol] ), it is useful to begin by deriving a generalized view of Special Relativity. An arbitrary region λ of spacetime will be examined. This could conceivably be our region/sub-universe/brane of existence. A generalized parameter of this region will also be used. Let this generalized parameter φ be defined as the maximum natural velocity (i.e. energy speed of propagation) in this region. Then one can derive the concepts of Special Relativity, based on parameter φ_{λ} in region λ.

For the purpose of this document (and to attempt leeward bearing to other naming conventions) the generalized derivation is referred to as the Light Gauge Theory (LGT). In this context “gauge” is defined as a standard of measurement, or a standard of observation. Additionally, the speed-of-light c, will also denote the velocity (vector) c. Thus, both the speed & velocity-of-light are denoted by c, for notational simplicity in this document.

The term “neighborhood” should be understood as the immediate volume of spacetime surrounding (and containing) the point, particle, or vehicle under discussion, in the context of this document.

### 1.2.2.1 The Light Gauge

### Given:

Two observers a distance x apart in a region λ of spacetime. An event happens at observer A's position, at time t, (x₁, x₂, x₃, t). The observer B, at position (x′₁, x′₂. x′₃, t′) also observes the event that happens at A's position.

### Let:

v_{λ} define the maximum propagation speed of signals in region λ
v_{λ}>c, v_{λ}>c_{λ}

This is a counter assumption that c is not necessarily universal, and that c_{λ} is not the maximum speed a signal can propagate in spacetime region λ. Two viewpoints/arguments are considered:

1. The maximum signal velocity, in a spacetime region, is unbounded (i.e. ∞)

2. The maximum signal velocity, in a spacetime region, cannot exceed some φ in that spacetime region, (e.g. φ_{λ}, for the spacetime region λ). One states that φ_{λ}≠_{λ}, can be viewed as the general case.

### Argument 1;

This 1^{st} viewpoint would imply instantaneous synchronization, and the observable simultaneity of diverse events. Instantaneous propagation is an oxymoron. It does not follow observable (or analytical) analysis.

### Argument 2;

This 2^{nd} viewpoint involves deriving a Lorentz transformation for a spacetime region. One then defines an inter-region transformation for observers in different spacetime regions, where the regions are sub-manifolds on the general Riemann Manifold of spacetime.

### 1.2.2.1.1 Modified Lorentz Transformation

For the remainder of this document, I consider the set of spacetime regions that are definable as sub-manifolds on the Riemann Manifold of spacetime. The Theory of General Relativity describes physical space (i.e. our spacetime region) as a manifold.

One considers, in spacetime region/(sub-manifold) λ, two observers moving relative to each other, at velocity v. For notational simplicity, one observer will be in an unprimed coordinate system, (xᵢ, tᵢ). The other observer is in a primed coordinate system, (x′ᵢ, t′ᵢ). One “assumes” (as in Special Relativity) that, at the origin of each reference frame, x=0, t=0.

Let:

x′=αx+v(βv·x+κt)

t′=ζv·x+ηt

α, β, κ, ζ, η fall from the pre-relativistic equations x′=x+vt, and t′=t Thus, α, κ, η approximate 1, and β, ζ approximate 0, when v<φ_{λ}. One defines c_{λ} as the speed of light in spacetime region λ. Let c_{λ}<φ_{λ}. If one assumes (according to Relativity) that the speed of light is constant, one has c_{λ}=c<c_{λ}.

If the primed coordinate system has a velocity v, in the unprimed coordinate system, and the unprimed coordinate system has velocity v in the primed coordinate system, one has the following;

$$If {x}^{′} = 0 , then x = - vt and if x = 0 , then {x}^{′} = {vt}^{′}$$

$$\begin{matrix}0 = - α vt + v ( β v \cdot vt + κ t ) \\ = - α vt + κ vt - β {v}^{2} \cdot {vt}^{2}\end{matrix}$$

$$α = § - β {v}^{2}$$

$${t}^{′} = ζ v \cdot x + η t$$

$${t}^{′} = - ζ v \cdot vt + η t$$

$$η t = ζ {v}^{2} t , ( where η = ζ for proper values of {v}^{2} )$$

One can now discuss the maximum signal velocity (φ_{λ}), possible in the λ region of spacetime. Assume that this maximum is universal, in the λ region of spacetime. In other words, (φ_{λ}) is the maximum attainable signal velocity in the λ region of spacetime, irrespective of the observer's coordinate system.

### Note;

1. Here, the λ region of spacetime is defined as a sub-manifold on the (general spacetime) Riemann Manifold.
2. Assume that φ_{λ} is a function of the curvature of spacetime region λ.
   (In the remainder of this document, for notational simplicity and confusion avoidance, φ_{λ} will be used interchangeably with φ_{λ}, to imply the vector φ_{λ})

Suppose at time t=0, an event occurs at x=0, the origin of the unprimed coordinate system in region λ. Then at any point in region λ (with coordinate x), a signal travelling at maximum velocity will arrive at x by:

φ²_{λ}t²=x²,t>0

this is also true for x′, thus φ²_{λ}t′²=x′²

$$\begin{matrix}x = - vt , & {x}^{2} = {v}^{2} {t}^{2} & ( for {x}^{′} = 0 ) \\ & {t}^{2} = {x}^{2} / {φ}_{λ}^{2} & \\ & {v}^{2} = {x}^{2} / {t}^{2} & \end{matrix}$$

$$\begin{matrix}α = κ - ( {x}^{2} / {t}^{2} ) β , κ = η \\ = κ - {v}^{2} β\end{matrix}$$

$${x}^{′} = {αφ}_{λ} t + v ( β v \cdot {φ}_{λ} t + κ t )$$

$$\begin{matrix}{t}^{′} = ζ v \cdot {φ}_{λ} t + κ t \\ = ( ζ v \cdot {φ}_{λ} + η )\end{matrix}$$

$$\begin{matrix}{φ}_{λ} {t}^{′} = {αφ}_{λ} t + vt ( β v \cdot {φ}_{λ} + κ ) \\ = ( ζ v \cdot {φ}_{λ} t + η t ) \\ = ( ζ v \cdot {φ}_{λ} + κ ) t\end{matrix}$$

$$\begin{matrix}ζ v \cdot {φ}_{λ} t + κ t = {αφ}_{λ} t + v β v \cdot {φ}_{λ} - t + κ vt ) \\ = {αφ}_{λ} t + v \cdot {φ}_{λ} t ( v β - ζ ) + κ t ( v - 1 ) \\ = α + v ( v β - ζ ) + ( κ / {φ}_{λ} ) ( v - 1 ) \\ = α + v ( v β + κ / {φ}_{λ} ) - ζ v - κ / {φ}_{λ} \\ = α + {v}^{2} β + ( κ / {φ}_{λ} ) ( v - 1 ) - ζ v\end{matrix}$$

Let:

$$β = v / {φ}_{λ} \\ then \text{:} \\ ζ v \cdot {φ}_{λ} t + κ t = {αφ}_{λ} t + v {v}^{2} t + κ v t \\ \begin{matrix}ζ v \cdot {φ}_{λ} + κ = {αφ}_{λ} t + v {v}^{2} + κ v \\ = α + v {v}^{2} / {φ}_{λ} + κ v / {φ}_{λ}\end{matrix} \\ \text{(} where ; \begin{matrix}α = κ - {v}^{2} β \\ = κ - {v}^{2} v / {φ}_{λ}\end{matrix} )$$

$$ζ v + κ / {φ}_{λ} = α + {v}^{2} β + κβ$$

$$ζ v + κ / {φ}_{λ} - {v}^{2} β - κβ = α \\ ζ v + κ ( ( 1 / {φ}_{λ} ) - β ) - {v}^{2} β = α \\ ζ v + κ ( 1 - {φ}_{λ} β ) - {v}^{2} β = α \\ κ + ( ζ v - {φ}_{λ} β ) - {v}^{2} β = α$$

where; (ζv−κφ_{λ}β)=0, under certain conditions

### 1.2.2.1.2 Inter-Region Transformation

### Given:

$$\begin{matrix}{x}^{2} + {y}^{2} + {z}^{2} - {φ}_{λ}^{2} {t}^{2} = ( {x}^{′2} + {y}^{′2} + {z}^{′2} - {φ}_{λ}^{′2} {t}^{′2} ) f ( v ) \\ = 0\end{matrix}$$

$${y}^{2} = {y}^{′2} , {z}^{2} = {z}^{′2} ⇒ no motion$$

$$\begin{matrix}{x}^{2} + {y}^{2} + {z}^{2} - {φ}_{λ}^{2} {t}^{2} = ( {x}^{′2} + {y}^{′2} + {z}^{′2} - {φ}_{λ}^{′2} {t}^{′2} ) f ( v ) \\ = 0\end{matrix}$$

$${x}^{2} - {φ}_{λ}^{2} {t}^{2} = {x}^{′2} - {φ}_{λ}^{′2} {t}^{′2}$$

Let;

λ(n)=1

x′(x,t)=kx+lt
t′(x,t)=mx+nt=>time(in one coordinate system)is a function of position, in another coordinate system

$$If \begin{matrix}{x}^{′} = 0 \\ = k ( vt ) + lt ,\end{matrix}$$

$$thus ; kv = - l$$

$${x}^{′} = kx - lvt$$

$${t}^{′} = mx + nt$$

where v is the relative velocity of the unprimed coordinate system, relative to the primed coordinate system

x²−φ²_{λ}t²=k²x²−k²xvt+k²v²t²−φ²_{λ}m²x²−φ²_{λ}mnxt−φ²_{λ}n²t

0=(k²−1−φ²_{λ}m²)x²−(k²v+φ²_{λ}mn)xt+t²(k²v²−φ²_{λ}n²+φ²_{λ})
since x and t are arbitrary

$${k}^{2} - 1 - {φ}_{λ}^{2} {m}^{2} = 0 , \\ {k}^{2} v + {φ}_{λ}^{2} mn = 0 , \\ {k}^{2} {v}^{2} - {φ}_{λ}^{2} {n}^{2} + {φ}_{λ}^{2} = 0$$

$${k}^{2} = 1 + {φ}_{λ}^{2} {m}^{2} , \\ {φ}_{λ}^{2} mn = - {k}^{2} v$$

$${k}^{2} v + {φ}_{λ}^{2} mn = 0$$

$$v + v {φ}_{λ}^{2} {m}^{2} + {φ}_{λ}^{2} mn = 0$$

substituting the expression (1+φ²_{λ} m²) for k² in (k²v²−φ²_{λ}n²+φ²_{λ}=0), one has

(1+φ²_{λ}m²)v²−φ²_{λ}n²+φ²_{λ}=0

(1+φ²_{λ}m²)v²=φ²_{λ}n²−φ²_{λ}

(1+φ²_{λ}m²)=φ²_{λ}(n²−1)/v²

m²=((n²−1)/v²)−1/φ²_{λ}

one now has an initial expression for m;

$$m = {( ( ( {n}^{2} - 1 ) / {v}^{2} ) - 1 / {φ}_{λ}^{2} )}^{1 / 2}$$

$${v}^{2} + {v}^{2} / {φ}_{λ}^{2} {m}^{2} - {φ}_{λ}^{2} ( ( v + v {φ}_{λ}^{2} {m}^{2} ) / {φ}_{λ}^{2} {m}^{2} ) + {φ}_{λ}^{2} = 0$$

$${v}^{2} / {φ}_{λ}^{{ }^{2}} {m}^{2} + {v}^{2} / {φ}_{λ}^{4} {m}^{4} - {v}^{2} - k {v}^{2} {φ}_{λ}^{2} {m}^{2} - {v}^{2} / {φ}_{λ}^{4} {m}^{4} + {φ}_{λ}^{2} {m}^{2} = 0 \\ - {v}^{2} - {v}^{2} / {φ}_{λ}^{2} {m}^{2} + {φ}_{λ}^{4} {m}^{2} = 0$$

$${m}^{2} = {v}^{2} / ( {φ}_{λ}^{4} - {v}^{2} {φ}_{λ}^{2} ) = {v}^{2} / ( 1 - ( {v}^{2} / {φ}_{λ}^{2} ) )$$

$${k}^{2} = 1 + {v}^{2} / ( {φ}_{λ}^{2} - {v}^{2} ) = {φ}_{λ}^{2} / ( {φ}_{λ}^{2} - {v}^{2} ) = 1 / ( 1 - {v}^{2} / {φ}_{λ}^{2} )$$

$$k = 1 / {( 1 - {v}^{2} / {φ}_{λ}^{2} )}^{1 / 2}$$

$$m = v / {( 1 - {v}^{2} / {φ}_{λ}^{2} )}^{1 / 2}$$

$$l = - v / {( 1 - {v}^{2} / {φ}_{λ}^{2} )}^{1 / 2} = - m$$

$$\begin{matrix}n = ( v + {v}^{2} / ( {φ}_{λ}^{2} - {v}^{2} ) ) / ( {φ}_{λ}^{2} v / {{φ}_{λ} ( {φ}_{λ}^{2} - v )}^{1 / 2} ) \\ = - 1 / {( 1 - {v}^{2} / {φ}_{λ}^{2} )}^{1 / 2}\end{matrix}$$

remembering that: x′=kx−lvt, t′=mx+nt

Letting; β=v/φ_{λ}
then;

x′=(x−vt)/(1−β²)^{1/2}

t′=(vx−φ²_{λ}t)/φ²_{λ}(1−β²)^{1/2}
after algebraic simplification

$$\begin{matrix}d {x}^{′} / d {t}^{′} = {v}_{x}^{′} \\ = ( d x - v d t ) / ( ( v d x / {φ}_{λ}^{2} ) - d t ) \\ = ( {v}_{x}^{′} - v ) / ( ( {vx}_{x} / {φ}_{λ}^{2} ) - 1 )\end{matrix}$$

$$d {y}^{′} / d {t}^{′} = {v}_{y}^{′} , d {z}^{′} / d {t}^{′} = {v}_{z}^{′}$$

$${dt}^{′} = ( ( vdx / {φ}_{λ}^{2} ) - dt ) / {( 1 - {β}^{2} )}^{1 / 2}$$

### 1.2.2.1.2.1 Length Contraction

x′₂−x′₁=(x₂−x₁)/(1−β²)^{1/2}

thus, an object measures shorter in coordinate system ξ′, when observed from coordinate system, ξ, ξ′ is in motion relative toξ.

### 1.2.2.1.2.2 Time Dilation

t₂−t₁=(t′₂−t′₁)/(1−β²)^{1/2}

### 1.2.2.1.3 Conclusions

By the above transformations, where β=v/φ_{λ}, a particle moving at velocity v≧φ_{λ} drives the transformation equations to infinity. Thus, in any given spacetime region λ, v≧φ_{λ} implies the particle is not observable in region λ, when measured by signals propagating (in region λ) at velocities v_{λ}<φ_{λ}.

### 1.2.3 φ_{λ} and Curvature

Einstein intuitively chose c (the natural speed of electromagnetic wave propagation in our spacetime region) to be the φ_{λ} of his derivations. This was apparently an intuitive choice, since the speed of light is the highest “natural velocity” observed in our spacetime region. One can state that c is a special case of the general case φ_{λ}. Also, for the generalized case, φ_{λ} can be greater than c.

For this work, the “natural speed” is defined as the velocity of propagation of electromagnetic energy along a geodesic. Since a geodesic curve is the result of spacetime curvature, the “natural speed” is arguably dependent on the curvature of spacetime. Thus, given a regional structure of spacetime, the curvature θ_{λ} of region λ determines φ_{λ}. Then
θ_{λ}=>φ_{λ}(θ_{λ}) is a function of curvature.
   This implies that the “generalized natural speed” is dependant on the curvature. For any spacetime region i, φᵢ (θᵢ); where θᵢ is the curvature of region i. Methods for calculating θᵢ, for our region of spacetime, are found in documents [1] and [2].

### 1.2.4 Inter-Region Relative Observations

For each inter-region observation, the related maximum of each region, (φᵢ, φⱼ, . . . ), must be derived. Examining motion in one region, while the observer is in another region, requires some additional considerations.

Initially, the thought is to algebraically add the regional maximum velocity vectors, (φᵢ, φⱼ), and treat the observer's region as stationary. The other region's velocity is (φᵢ+φⱼ), relative to the observer's region. This sum can be regarded as logically equivalent to Einstein's c, for inter-region relative motion.

### 1.3 SPACETIME REGIONS

### Some Possible Ramifications

If (as a brief aside) one examines a regional structure of spacetime, several factors might follow.

The regions of spacetime, if dynamic (in size and/or other properties), could account for several phenomena (both observed and predicted). Considering the curvature parameter, if one examines regional curvature, as the regions become smaller;
Let:

$${W}_{i} = volume of the {i}^{th} region of spacetime$$

$$\begin{matrix}{λ}_{i} = curvature of the {i}^{th} region of spacetime \\ = f ( {W}_{i} , … )\end{matrix}$$

$$\partial {λ}_{i} / \partial {W}_{i} = \partial f ( {W}_{i} , … ) {dq}_{i} / \partial {W}_{i} , \\ where {q}_{i} is a generalized coordinate$$

Then:

$${limit f}_{Wi -> 0} ( {W}_{i} , … ) { limit {λ}_{i}}_{Wi -> 0} \approx$$

$$Where is an approximation of curvature / gravity in a quantum framework ?$$

It is interesting to note that, where Wᵢ approaches the Planck-Scale, neither Relativity nor Quantum Theory accurately predicts the behavior of matter.

By the Theory of General Relativity, all of space is a manifold. Therefore one can consider regions as submanifolds of spacetime. A region of spacetime is a set of points. If one considers regional curvature (i.e. curvature of a given region of spacetime) as a “relation or operation” on the set of points defining a region, then the curvature operation arguably has transitivity, identity (i.e. flat/zero-curvature), and an inverse (i.e. negative curvature) on the points of said region. The region can then be called a group. Since the region is a manifold, the region is also a lie-group. Generalizing, one can view spacetime as a set of lie-groups.

Regions containing singularities (e.g. black holes) could be analyzed using the orbitfold-based arguments of M-Theory. This might also be useful in analysis of regional boundary conditions. A “regional structure” of spacetime would mean that a given region is bounded by a set of other regions. Thus, obviously, the boundary conditions of a given region would be a summation of its sub-boundaries with members of its set of bounding/connecting regions. An orbitfold-based approach might be useful in analyzing such boundary conditions, as well as regional singularities (e.g. black holes). The main suggestion here is, given region size, the same analysis methods might hold, whether micro or macro regions are considered. Conceptually, macro-regions could be described using the “brane” structure of M-Theory. Micro-regions could be used to describe quantum behavior/properties of curvature. As region size “theoretically” approaches zero, regional size encounters the Planck-Scale. Below the Planck-Scale, present knowledge prevents accurate prediction of behavior.

Descriptions of curvature/gravity (under a regional structure) might therefore offer a way to incorporate a quantum framework that includes gravity, when micro-regions are considered.

### 1.4 SUMMARY

The cursory discussion of this section 1, establishes the conceptual background of the invention. A second objective of this background section is to suggest a possible approach to the problem of incorporating gravity into a quantum framework. Some additional considerations might be useful. They are as follows;
(1) Photon behavior is described, as to the “view of an observer”, in a local coordinate-system (i.e. reference-frame). If spacetime consists of regions, then a region around a black hole has its own preferred reference frame.
(2) A Postulate: Regions of spacetime might have different properties. Thus, they might have preferred local frames-of-reference (i.e. coordinate systems). If so, a particular region, depending on its curvature (and size) might accommodate Relativity or Quantum Theory. This could form the basis for a Quantum Theory of Gravity/(spacetime-curvature).
   The focus of the remainder of this document is our spacetime region, its curvature, its torsion, and resulting applications such as geodesic-fall ( [symbol] ), in our region of spacetime.

### 2. SUMMARY OF INVENTION

The invention is based on the new ECE-Theory of cosmology. The ECE (Einstein-Cartan-Evans)-Theory [13-15] is a generally covariant unified field theory, developed by Prof. Myron W. Evans in 2003. A major principle of the ECE-Theory is that electromagnetism and gravitation are both manifestations of spacetime curvature. More specifically, electromagnetism is the torsion of spacetime, and gravitation is the curvature of spacetime. Since torsion can be viewed as spin, one concludes that spacetime has both curvature and spin. The spinning/torsion of spacetime was neglected in Einstein's Theory of Relativity. Einstein also arbitrarily (and incorrectly) assumed c (the speed of light) could not be exceeded. The ECE-Theory also shows that coupling between the background potential of spacetime can be established by appropriate electrical and/or mechanical devices. This coupling manifests as amplification of the potential (in volts) of such devices, as said devices resonate with the background potential energy of spacetime. This phenomenon is called spin-connection-resonance (SCR), [16, 17]. Some engineering principles, for such devices, are discussed in [18]. The invention is a device that employs some of the engineering concepts discussed in [18]. One purpose of the invention is to demonstrate SCR and other principles of ECE-Theory. Fundamentally, ECE-Theory is a combination of Einstein's geometric approach and Cartan Geometry to describe the nature & structure of spacetime. Cartan Geometry [15] adds torsion to the Riemann Geometry used by Einstein in his Theory of Relativity. Thru ECE-Theory, electromagnetism can be expressed as the torsion of spacetime. The basic set of ECE-Theory equations describes both gravitation and electromagnetism.

### 2.1 SPIN CONNECTION RESONANCE (SCR) EFFECTS

The ECE-Theory allows the interaction of the electromagnetic field and the gravitational field. A generally covariant unified field theory, such as ECE-Theory, allows such interaction. This field interaction is defined in [17]. The significance of ECE-Theory is illustrated by considering two charged masses interacting. There is an electrostatic interaction between the charges, and a gravitational interaction between the masses. On the laboratory scale, the electrostatic interaction is orders-of-magnitude greater than the gravitational interaction. Thus, gravitational interaction has not been measured, on the laboratory scale. In ECE-Theory, the interaction between the electrostatic field and the gravitational field can be controlled by the homogeneous current (of ECE-Theory), which is given in [17]. The homogeneous equation (in tensor form) of ECE-Theory is;

∂_{μ}F^{μv}=j^{v}/∈₀
Where; F→>electromagnetic field tensor
   J→>homogeneous current density
μv→spacetime indices
∈₀→vacuum permeability
   given in [19]. It is shown in [17], that for a given initial driving voltage, the effect of the interaction of the electromagnetic field with the gravitational field is significantly amplified (as is the effect of the electromagnetic field on the Newtonian force), in a direction opposite to the gravitational field. As shown in [17], the inhomogeneous current is derived from the covariant Coulomb Law. When the potential energy of the interaction resonates with the background potential energy of spacetime, SCR is achieved. At SCR, amplification of the potential of the interaction term occurs in a direction opposite to gravitation. This produces a counter-gravitation effect.

### 2.2 GENERIC CONCEPTS

### 2.2.1 Basic Physical Laws (Under ECE-Theory)

Considering the Coulomb Law under ECE-Theory, from [19] we have;

∇·E=ρ/∈₀

Where: E=−∂A/∂t−∇φ−ω₀A+ωφ

∇·(−∂A/∂t−∇φ−ω₀A+ωφ)=ρ/∈₀

In spherical coordinates we have the resonance equation 14.32 of [17]

d²φ/dr²+(1/r−ωᵢₙₜ)dφ/dr−(1/r²+ωᵢₙₜ/r)φ=−ρ/∈₀
Where; ωᵢₙₜ→the interaction spin connection
   Considering the Poisson equation {∇₂φ=−ρ/∈₀} of the Standard Model, and introducing the vector spin connection ω of the ECE-Theory, one has the following:

∇·(∇φ+ωφ)=−ρ/∈₀ The ECE Poisson equation

∇²φ+ω·∇φ+(∇·ω)φ=−ρ/∈₀ 9.6 of [20]

This equation, 9.6 of [10], has resonance solutions. From the ECE-Theory and [15], it is shown that the gravitational field curves spacetime. It is also shown that the electromagnetic field curves spacetime, but by spinning spacetime.

### 2.2.1.1 Magnetic Levitation (Mag-Lev)

The equivalence of gravity and electromagnetism has been established in references [6] and [7]. The process of magnetic levitation (mag-lev) is described in [10]. This mag-lev process, where;
M_{B}=>strength of base magnet
M_{L}=>strength of levitation magnet
   (usually attached to a vehicle, such as a mag-lev train)
      is equivalent to the counter-gravitation process presented in this document. The force between the base (M_{B}) and the vehicle (M_{L}) is referred to as the heave-force h, in mag-lev applications. The heave-force neutralizes gravity locally. This is a manifestation of spacetime curvature, and one has the following;

h=h(M_{B},M_{L})

h≈ [symbol] where: [symbol] = [symbol] (M_{B},M_{L})

Before deriving an elementary set of equations-of-motion for [symbol] , it is useful to summarize the invention. In a generalized mag-lev application, the base-magnet M_{B} and the lev-magnet M_{L} are both used to levitate matter in an anti-gravity region (between M_{L} and M_{B}) resulting from the interaction of the magnetic fields of M_{L} and M_{B}.

The heave-force h is now used to derive an expression for [symbol] (M_{B}, M_{L}).

### 2.2.1.1.1 Equations of Motion

The Ricci Tensor (in terms of M_{L} and M_{B}) can define the heave-force/induced-curvature of the mag-lev effect resulting from M_{L} and M_{B}. From document [10], (noting that a vector is a tensor of rank 1), one has the expression

h=μ₀I²β/2πz=Fₕ
where: β=coil length
   I=current
   μ₀=a magnetic constant
Fₕ=μ₀I² ƒ(D/φ) is the heave force description
   where: D=a magnet dimension (electric flux density)
      φ=separation of M_{B} (base) and M_{L} (lev-vehicle)

F_{g}=qE+(qv×B) is the EM/gravity description (Ricci Tensor) for change in q at velocity V.

Fₕ≡F_{g},μ₀I²ƒ(D/φ)=qE+(qv×μH)
where: H=B/μ
   qE+(qv×μH) is the Lorentz Force law
      Again from document [10], F is defined as follows;

F=M_{L}M_{B}/r² (where r is the distance between magnets M_{L} and M_{B})

R_{μv}=−KT_{μv} is the Ricci Tensor, T_{μv} is the Energy-momentum Tensor, and μv are translation and rotation coordinates respectively.

If F and R_{μv} are both expressions of spacetime curvature, one has the following;

$${M}_{L} {M}_{B} / {r}^{2} \begin{matrix}= {KT}_{μ v} \\ = {R}_{μ v} ( {M}_{L} , {M}_{B} ) \\ =\end{matrix}$$

With an expression for [symbol] in terms of M_{L} and M_{B}, it is possible to define a set of “equations-of-motion”.

### DEFINITIONS

[symbol] —the (M_{L} and M_{B} induced curvature) geodesic path velocity of a vehicle

∫ [symbol] —dt—position (along the induced curvature) geodesic path

d [symbol] dt—acceleration (along the induced curvature) geodesic path

The curvature induced by M_{L} and M_{B} is equivalent to the heave-force h (i.e. mag-lev effect) induced by M_{L} and M_{B}. This defines a simple set of equations-of-motion for geodesic-fall.

### 2.2.1.1.1.1 Equations-of-Motion Conclusions

Gravitation and Electromagnetism are respectively the symmetric and antisymmetric parts of the Ricci Tensor, within a proportionality factor. Gravitation and electromagnetism are both expressions of spacetime curvature. Thus the mag-lev heave-force is also an expression of spacetime curvature, and h and [symbol] are arguably equivalent.

Obviously, a more rigorous derivation can lead to a fully comprehensive set of equations-of-motion. These equations-of-motion can be the basis for a propulsion system, based on the induced curvature of spacetime. It is expected that the above derivation and many of its attendant ramifications will be understood from the forgoing, and it will be apparent that various changes may be made in rigor and detail of the derivation, without departing from the spirit and scope of the derivation or sacrificing all of its advantages, the above derivation merely being an example thereof.

### 2.2.1.1.2 Example Propulsion System (Geodesic-Fall)

Gravity is a manifestation of the curvature of spacetime. Due to the equivalence of gravity and electromagnetism (i.e. gravitation and electromagnetism are respectively the symmetric and antisymmetric parts of the Ricci Tensor), electromagnetism is also a manifestation of spacetime curvature. Thus, by “proper use” of electromagnetism, spacetime curvature can be induced. Mag-lev technology is an example of this. The term, “proper use”, herein means specific configurations of electromagnetic forces can produce/induce desired curvature of spacetime.

A geodesic is defined in [2], as a curve uniformly “parameterized”, as measured in each local “Lorentz frame” along its way. If the geodesic is “timelike”, then it is a possible world line for a freely falling body/particle.

As stated in [2], free fall is the neutral state of motion. The path through spacetime, of a free falling body, is independent of the structure and composition of that body. The path/trajectory of a free falling body is a “parameterized” sequence of points (i.e. a curve). The generalized coordinate qᵢ is used to label/parameterize each point. Generally, qₜ refers to time. Thus, each point (i.e. parameterized point) is an “event”. The set of events (i.e. ordered set of events) is the curve/trajectory of a free falling body. In a curved spacetime, these trajectories are the “straightest” possible curves, and are referred to as “geodesics”. The parameter qₜ (defining time) is referred to as the “affine parameter”.

A Lorentz frame, at an “event” (∈₀) along a geodesic, is a coordinate system, in which

g_{μv}(∈₀)≡η_{μv}

and g_{μv}≈η_{μv} in the neighborhood of ∈₀,

$$where \text{:}$$

$$\begin{matrix}μ ⇒ & translation coordinate \\ v ⇒ & rotation coordinate \\ {η}_{μ v} ⇒ & Minkowski Tensor ⇒ \\ {g}_{μ v} ⇒ & metric tensor\end{matrix} \{ \begin{matrix}1 ⇒ μ = v = 1 , 2 , 3 \\ - 1 ⇒ μ = v = 0 \\ 0 ⇒ μ \neq v\end{matrix}$$

The relationship between two points/events can be spacelike or timelike. The spacetime interval between two events ∈ᵢ, ∈ⱼ is given by;

dτ²=dt²ᵢ−(1/c²)d∈ᵢ²=dt²ⱼ−(1/c²)d∈ⱼ²

dσ²=d∈²ⱼ−c²dtᵢ²=d∈²ⱼ−c²dtⱼ²

Depending on the relative magnitude of dt and d|∈|/c, dτ or dσ a will be real-valued. If dr is real, the interval is timelike. If dσ is real, the interval is spacelike. The degree of curvature can determine the relationship between points/events along a geodesic, resulting from such curvature. Thus, curvature defines a geodesic. A given curvature of spacetime produces a set of geodesics. A properly controlled particle (or vehicle) can “fall” along a given geodesic. For vehicular motion along a geodesic, “proper control” is defined as the “relative configuration control” of electromagnetic sources that are hosted by said vehicle. A “dynamic” configuration control could serve as a means of vehicular control & navigation in fall motion along a geodesic resulting from induced spacetime curvature. Such motion is referred to as geodesic-fall ( [symbol] ). The horizontal instability of the LEVITRON device is an example of uncontrolled [symbol] . The magnetic sources properly attached to a vehicle could cause said vehicle to move (i.e. fall) along the geodesic path induced by the anti-gravity region. This process can be observed as the Levitron top falls away from its base, when the top's angular momentum slows below the minimum required for stability [11, 25].

The properties of geodesic-fall are determined by the degree of spacetime curvature. The motion of a particle/vehicle along a geodesic (in curved spacetime) depends on the degree of curvature enabling that geodesic. The velocity vector [symbol] (under induced spacetime curvature) is dependent on the “degree” of that induced curvature. Thus, [symbol] is not constrained by c (the speed of light in normal/our spacetime). The velocity vector [symbol] is constrained only by the magnitude and configuration of the sources inducing the spacetime curvature.

It is important that one not come to the erroneous conclusion that Geodesic-Fall involves moving a vehicle by magnetic forces. The Geodesic-Fall concept is a secondary effect resulting from induced spacetime curvature.

### 2.2.1.1.3 Levitron Dynamics

ECE-Theory easily explains the Levitron. As is [11], one can regard the levitron top as a magnetic dipole. Thus, the Levitron can be viewed as a demonstration-device for ECE-Theory. The Levitron employs counter-rotating magnetic fields to achieve its counter-gravity effect. It falls in the class of devices defined in [18].

### 2.2.1.1.3.1 A Note on Counter-Rotation

We note once again that, for the Levitron, M₁ is attached to the top (s), M₂ is the base. Device operation shows the top must spin to levitate stably above the base. More correctly, M₁ is required to spin.

### Let:

v_{M1}, v_{M2}→rotational velocities of the magnets
for counter-rotation (v_{M1}+v_{M2})→vᵣ relative velocity.
   If v_{M2}=0, then we have the Levitron case. For levitation, vᵣ must be positive. Thus, one argues the Levitron top must spin. However, it is M₁ that is required to spin.

It is useful to note that the explanations of the Faraday disk generator [24], are similar to those of this section. The explanations of the Faraday disk (homopolar) generator incorporate ECE-Theory. It has been fully explained by ECE-Theory.

### 2.2.1.1.3.2 The Spin/Rotation Requirement

For the Levitron, a spin component is needed to couple with spacetime torsion, to achieve spin-connection-resonance (SCR). This spin component must exceed some β to maintain SCR and stability. Stated more precisely, from the above discussion;
vᵣ≧β→stability of top above the base
vᵣ<β→instability of top, causing it to fall
   If the Levitron's v_{M1} spin/rotation component is less than β, the top falls away along a geodesic path induced by the anti-gravity condition caused by the interaction of the Levitron's ring magnet (M₁), and magnetic base (M₂). This factor is exploited as a propulsion system concept in [25].

### 2.2.1.1.3.2.1 Quantitative Analysis Using ECE-Theory

Starting with the ECE Poisson equation:

∇·(∇φ+ωφ)=−ρ/∈₀

∇²φ+ω·∇φ+(∇·ω)φ=−ρ/∈₀ 9.6 of [20]

From section 4.3 of [25], we have the following;

(∇μ₁(t)·B₁(r)+∇μ₂(t)·B₂(r))=φ₈₀

From [6] we have the following resonance equation;

d²φ/dr²+(1/r−ωᵢₙₜ)dφ/dr−(1/r²+ωᵢₙₜ/r)φ=−ρ/∈₀ 14.32 of [17]
Where; ωᵢₙₜ→the interaction spin connection
   From Coulombs Law ∇·E=ρ/∈₀, one also has E=∇φ. Using φ_{λ} one has the following;

∇²φ_{λ}=ρ/∈₀(where φ_{λ} is the driving function)

The driving function φ_{λ} determines the degree of induced curvature F(μᵢ, Bᵢ). Let;

(∇μ₁(t)·B₁(r)+∇μ₂(t)·B₂(r))=φ_{λ}

∇(μ₁(t)·B₁(r))+∇(μ₂(t)·B₂(r))=M₁(r)+M₂(r)= (1)

dφ_{λ}/dr=dM₁/dr+dM₂/dr (2)

d²φ_{λ}/dr²=d²M₁/dr²+d²M₂/dr² (3)

substituting in 14.32 of [17], one has the following;

−ρ/∈₀=(d²M₁/dr²+d²M₂/dr²)+(1/r−ωᵢₙₜ)(dM₁/dr+dM₂/dr)−(1/r²−ωᵢₙₜ/r)(M₁(r)+M₂(r)) (4)

−ρ/∈₀=d²M₁/dr²+d²M₂/dr²+dM₁/rdr−ωᵢₙₜdM₁/dr+dM₂/rdr−ωᵢₙₜdM₂/dr−M₁/r²−M₁ωᵢₙₜ/r−M₂/r²−ωᵢₙₜM₂/r (5)

From section 4.1 of [25], we use the expression derived for H, the geodesic-fall path velocity of a vehicle;

$$\begin{matrix}{M}_{1} {M}_{2} / {r}^{2} \approx - κ {T}_{μ v} \\ = H\end{matrix}$$

We then have the following;

$$\begin{matrix}{M}_{1} \approx {r}^{2} K {T}_{μ v} / {M}_{2} \\ d {M}_{1} / d r \approx - {rKT}_{μ v} / 2 {M}_{2} \\ {d}^{2} {M}_{1} / d {r}^{2} \approx - {KT}_{μ v} / 2 {M}_{2}\end{matrix} \} substituting into eq . ( 5 )$$

after some algebraic simplification, one has the following;

d²M₂/dr²+(1/r−ωᵢₙₜ)dM₂/dr+ωᵢₙₜKT_{μv}(r+2)/2M₂−(M₂+rM₂ωᵢₙₜ)/r²=−ρ∈₀

d²M₂/dr²+(1/r−ωᵢₙₜ)dM₂/dr−(1+rωᵢₙₜ)M₂/r²=−ρ/∈₀+Constant (6)

Equation (6) is a resonance equation in M₂

An expression for a resonance equation in M₁, can also be derived in a similar manner. Considering the ECE Poisson equation;

∇²φ+ω·∇φ+(∇·ω)φ=−ρ/∈₀

Arguably, SCR can be achieved relative to M₁, M₂, or φ. The counter-rotation of M₁ and M₂ is needed to amplify φ via SCR. This provides the counter-gravitation effect, and is thus the reason why the magnet (M₁), must spin, if counter-gravitation is to be maintained. This is a direct consequence of ECE-Theory.

### 2.2.1.1.4 Generalized (Alternative Counter-Rotation) Case

For the Levitron case, M₁ is attached to the top (s), M₂ is the base. A generalization of this concept is an object (e.g. the Levitron's top) spinning between the M₁ and M₂ magnetic sources. If the object is magnetized (i.e. M₃), one has M₃ rotating relative to M₁ and M₃ rotating relative to M₂ simultaneously. Thus, counter-rotation of M₃ and M₁, and of M₃ and M₂ is realized. This results in levitation of the object. Analytically, from section 2.2.1.1.3.1 above, where; x

v_{M1}, v_{M2}→rotational velocities of the magnetic sources
v_{M3}→rotational velocity of the object
   If v_{M1}=V_{M2}=0, and v_{M3}>0, anti-gravity regions are produced between (counter-rotating) M₃ and M₁, and between (counter-rotating) M₃ and M₂, causing the object to levitate. This is the basic configuration of the invention.

### 2.3 INVENTION STRUCTURE & CONFIGURATION

The basic structure of the invention is two counter-rotating magnetic sources mounted on a stand, which separates the magnetic sources by a given space, such that a counter-gravitational region is induced in said space. The fundamental configuration of this structure is shown in FIG. 4. Matter in this induced counter-gravitational region levitates, or in other words behaves as matter in a zero-gravity environment, such as outer-space. Other configurations of the invention are show in FIGS. 4 thru 6. In these applications (usually large type applications), the matter inside the induced counter-gravitational region can serve as the stand, for the magnetic sources. More precisely, the magnetic sources are attached to the levitated matter.

### 2.3.1 The Magnetic Sources

It is important to note that the invention's magnetic sources do not have to be permanent magnets. The magnetic sources can range from electromagnets to electromagnetic-arrays, to IFE (Inverse Faraday Effect) [21, 22] induced type magnetic sources.

### 2.3.1.1 IFE and RFR (Radiatively-Induced Fermion Resonance)

It is a well known fact (among competent physicists, but not necessarily patent examiners) that circularly polarized electromagnetic radiation can magnetize matter. Further, properly configured radio-frequency systems can produce circularly polarized electromagnetic radiation. This process is referred to as Radiatively-induced Fermion Resonance (RFR). Examining RFR in the context of ECE-Theory, one examines eqs. 11.16 and 11.17 of [22].

A=A⁰(i cos φₗ+j sin φₗ) 11.16 of [22]

φₗ=ωₗt−kt 11.17 of [22]

Equation 11.16 is the vector potential of circular polarized radiation. Equation 11.17 is the scalar potential of circular polarized electromagnetic field. Parameters ωₗ and κ depend on the properties of the circular polarized radiation source. Using the Resonate Coulomb Law from [19].

∇·∂A/∂t−∇·(ω₀A)−Δφ+∇·(ω)φ)=ρₗ/∈₀

substituting;

φ=φₗ+φ_{λ}→where φ_{λ} is as defined in [25]

A=A⁰(i cos φₗ++j sin φₗ)+(μ₁(t)×B₁(r)+μ₂(t)×B₂(r))

The μᵢ and Bᵢ expressions define the torque (due to M₁ and M₂) of the invention. From the Schrodinger theory of quantum mechanics, an object moving under a force F, has a potential energy V, related to F by;

F(q)=∂V(q)/∂q→where q is a generalized coordinate

∫F(q)dq=V(q)

Thus, letting F=(μ₁(t)×B₁(r)+μ₂(t)×B₂(r)), one has an expression for the vector potential under RFR;

A=A⁰(i cos φₗ+j sin φₗ)+V(q)

The potential due to the counter-rotating magnets is added to the potential due to the circular polarized electromagnetic energy. Therefore RFR/IFE can theoretically add significantly to the SCR process for anti-gravity. From the preceding discussion, it can be argued that a magnetized object is most optimal for ECE anti-gravity type applications. Also (given the above expression for A), it is obvious that magnetization of an object by RFR/IFE can add to the overall ECE anti-gravity effect.

Using RFR, instead of permanent magnets, additional flexibility & optimization can be achieved for ECE anti-gravity and power generation. As example, the M₁ and M₂ magnetic sources of the invention, can be implemented using RFR, instead of permanent magnets (including electromagnets), for the magnetic sources. As an example, The danger from cosmic rays must be addressed if deep space travel (e.g. inter-planetary travel, etc.) is to be realized. FIG. 6 shows a possible configuration where the ship's hull is magnetized by RFR methods. While enhancing the anti-gravity process, as described above, magnetization of the ship's hull also provides a shield against cosmic rays, whether or not the ship is in motion.

### 2.3.2 Operational Considerations

Considering the structure of the invention, the expressions for the torque forces due to the M₁ and M₂ magnetic sources in tangent space [symbol] ,

[symbol]

=μ₁(t)×B₁(r), [symbol] =μ₂(t)×B₂(r)

Given base vectors eₘ₁, eₘ₂ defining a tangent space to [symbol]
where; [symbol] →“bubble”, an arbitrary base manifold

eₘ₁= [symbol] eₘ₂

coordinate system of M₁ rotates relative to coordinate system of M₂

e^{ik}q^{m1}= [symbol] q^{m2}

from ECE-Theory

Aₘ₁^{m2}=A⁰

[symbol]

Interpreting the anti-gravity effect at [symbol] as a field of force (characterized by the coordinate system of [symbol] rotating with respect to [symbol] ), and another field of force (characterized by the coordinate system of [symbol] rotating with respect to [symbol] ). These forces are additive if the magnetic sources M₁ and M₂ are counter-rotating. This is a cursory (but more fundamental) argument for counter-rotation of M₁ and M₂ magnetic sources.

### 2.3.3 An Electric Power Generation Application (Example)

The anti-gravity region can be used for several applications ranging from power generation to vehicular propulsion. For example, a large version of the invention could be used to house an MHD (Magnetohydrodynamic) power generation process. The MHD process would take place inside the anti-gravity region. Thus, the process would be more efficient when the gravitational component in the basic MHD equation
MHD electric-power generation involves forcing an electrically conducting fluid through a channel (e.g. tube) at velocity v, in the presence of a magnetic field. This magnetic field B, must be aligned perpendicular to the tube. A charge Q, is then induced in the field. Under proper conditions, an electric current flows (in the fluid) in the direction of the electric field E. In an electromagnetic field, we have E perpendicular to B (i.e. E⊥B). Electrodes in contact with the fluid can tap the resulting electric current, which is the output of an MHD electric-power generation process. The Lorentz Force Law;

F=Q·(v×B)

governs this process. Generically, a charged particle q has what is termed a “cyclotron rotation” when encountering a magnetic field perpendicular to its velocity v. In a gravitational field, such as that of Earth, there is a drift velocity (where β is defined as a measure of magnetic pressure in a static field)

v_{D}=(mc/βq)(g×B)/β²

The “cyclotron rotation” is defined as;

ω_{C}=qβ/mc

thus

v_{D}=(g×B)/βω_{C}

If the MHD electric-power generation process is operated in a zero-gravity environment, the drift velocity vanishes. If the MHD electric-power generation process is operated in a reduced-gravity (g_{R}) environment, the drift velocity is also reduced. These factors can increase the efficiency of an MHD electric-power generation process. Clearly, a properly aligned negative gravitational environment could add to the velocity v of the charge q. For an MHD electric-power generation process, the fluid velocity v could be thus increased, adding to the overall efficiency of said MHD electric-power generation process.

### 2.4 CONCLUSIONS

Several concepts are presented in this application, which will appear alien to those not versed in, or unable to grasp ECE-Theory, which requires an understanding of the fundamentals of Einstein's Theory of Relativity, and Cartan Geometry. However, the discussions in this document should be comprehendible to any “competent” undergraduate physics student. Sections 1 and 2 of this application include introductions to basic scientific concepts involved with the invention. An elementary introduction to ECE-Theory is also provided. As an example, the Light Gauge Theory of section 1.2.2.1 is a generalized derivation of Special Relativity, wherein Einstein's assumption that the speed-of-light (c) is the maximum achievable velocity, is removed. The Light Gauge Theory should not be foolishly interpreted as a play on mathematics with no scientific basis.

### 2.4.1 Electromagnetism and Gravitation

Spacetime curves and spins. This has been shown in several scientific works, such as [7] and [15]. The spin of spacetime is referred to as torsion. Electromagnetism is the torsion of spacetime. Gravitation is the curvature of spacetime. Einstein neglected torsion in his Theory of Relativity. Thus, the Theory of Relativity is incomplete. Einstein spent his later years, unsuccessfully trying to expand Relativity into a unified field theory. ECE-Theory successfully accomplishes this. Torsion can be viewed as a form of curvature. Thus, in the generic sense, one can state that both electromagnetism and gravitation are manifestations of spacetime curvature. This leads to the obvious conclusion that the speed-of-light (c) is a function of spacetime curvature. This, however, would be alien to anyone intellectually constrained by the old Relativity Theory.

### 2.4.2 The Levitron and ECE-Theory

The Levitron [11] is a device, marketed as a scientific toy, comprising a base magnet and a magnetic top that spins levitated above the base. Thus, it involves the interaction of two forms of magnetized matter. Its dynamics can be explained by ECE-Theory. As stated in [11], no “quantitatively accurate” description of Levitron dynamics existed. ECE-Theory was used to derive such a description [23]. For example, the spinning requirement of the top can be explained by SCR of the ECE-Theory.

### 2.5 PRIOR ART

Previous endeavors in electromagnetic based propulsion were focused on mag-lev technology. High-speed trains are principal applications. The train/vehicle contains the magnet (referred to in this document as) M_{L}. The track/guideway generally contains the base magnet M_{B}. The heave-force is generated by mutual repulsion of M_{L} and M_{B}. This reduces friction and provides dynamic characteristics similar to air-cushioned hovercraft type vehicles. Propulsion of mag-lev trains is generally achieved by creating a traveling magnetic wave in the guideway/base. This traveling wave pulls M_{L} along in the horizontal plane, thus providing propulsion. The process presented in this document uses only an equivalent heave-force, for both propulsion and control.

The LEVITRON device is a toy top that can be made to spin while levitated above a magnetic base. Some West Coast toy companies market the toy. Physical principles governing the LEVITRON are similar to those exploited by the geodesic-fall process. The LEVITRON device is arguably a “miniaturized” example of a mag-lev like process. Aspects of the LEVITRON device behavior are used herein to illustrate the geodesic-fall process dynamics, on the laboratory scale.

### 3. BRIEF DESCRIPTION OF DRAWINGS

FIG. 1 LEVITRON device basic configuration

FIG. 2 LEVITRON magnetic field dynamics

FIG. 3 LEVITRON plus spinner type device

FIG. 4 An anti-gravity device configuration

FIG. 5 Generic anti-gravity configuration
(Magnetic Sources Attached to Levitated Matter)

FIG. 6 Levitated matter configuration
(Using RFR magnetization)

### 4. DETAILED DESCRIPTION OF INVENTION

The invention has several fundamental embodiments which are described in the following sections. Other embodiments are derived from these fundamental embodiments.

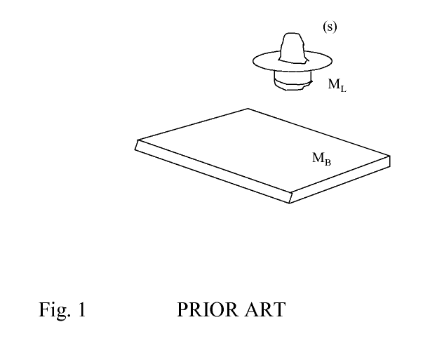

Regarding FIG. 1, the basic configuration of the LEVITRON device is illustrated. It (the LEVITRON) consists of a top (s), a magnet (M_{L}) attached to the top, and a base which is/contains the magnet (M_{B}). The top can be made to spin, while levitated above the base. The spin of the top is necessary to maintain the levitated equilibrium. If the top were not spinning, the force of magnetic torque (from M_{B}) on M_{L} would force the top to turn over, thus destroying equilibrium and stability. These principles are explained in [11]. Generally the spin of the top causes the torque to “precess” around the direction of the vertical heave-force h resulting from the natural repulsion of M_{L} and M_{B}. This “precession”, about the force h, prevents the top from overturning and preserves equilibrium and stability. Equilibrium and stability are lost when the top's rpm falls below a stability value. The top then tends to fall (out of equilibrium, to the left or the right) to the floor. This fall is an example of uncontrolled geodesic-fall, as the path of fall is determined by the relative configuration of M_{L} and M_{B} at the time of instability.

The spin rpm degradation is due primarily to friction and other mechanical forces.

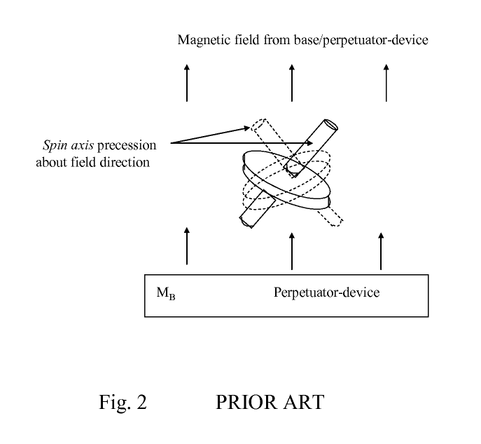

Regarding FIG. 2, the generic configuration of the magnetic effects of a spinning LEVITRON top and a Perpetuator-device are illustrated. The Perpetuator-device is a part of an advanced package of the LEVITRON toy system. It is an EM pulse device, and holds M_{B}. Generally, EM pulses, from the Perpetuator-device, re-enforce M_{B} and slow the degradation of the top's precession. Thus, an increase in the period of LEVITRON stability is achieved.

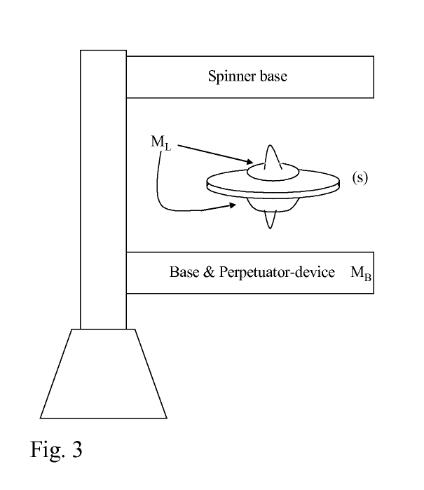

Regarding FIG. 3, a combination of the LEVITRON toy system and a spinner type toy system is illustrated. Spinner toys are those in which a top is made to continually spin on a surface. The surface contains a circuit (spinner-circuit) that interacts with the magnet in the top. This interaction re-enforces the top's spin. An example of a spinner type toy is given in [12]. Given the device of FIG. 3, equilibrium and stability are lost when the Perpetuator-device and/or the spinner-circuit are turned off. The resulting fall of the top is an example of unstable geodesic-fall.

For the generic configuration of the invention, the spinner and perpetuator devices are replaced with basic magnetic sources M₁ and M₂ respectively. The magnetic sources M₁ and M₂ remain stationary, while a third magnet M₃ is spun in the region between them (thus M₃ is counter-rotating with both stationary M₁ and M₂ to achieve SCR), causing this third magnetic material M₃ to levitate in the resulting anti-gravity region. This process is explained in sections 2.1 and 2.2.1.1.4 above. The anti-gravity region can be viewed as the sum of two anti-gravity sub-regions.

In a generalized configuration, both M_{L} and M_{B} would be attached to the device (s). The device (s) is a top (in the case of the LEVITRON), or a vehicle (in the case of mag-lev systems). Both M_{L} and M_{B} would be electromagnetic type systems, that could be controlled individually.

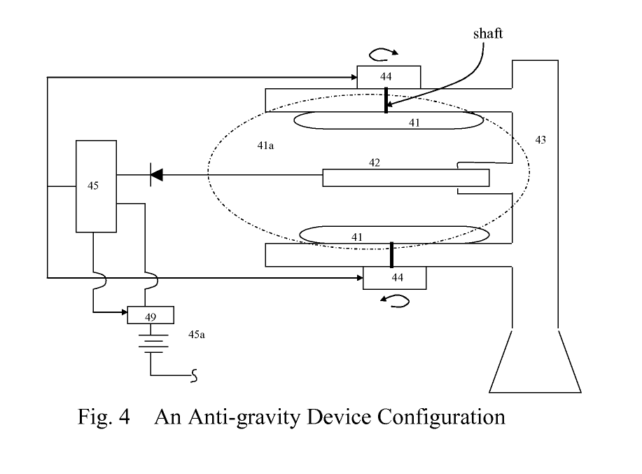

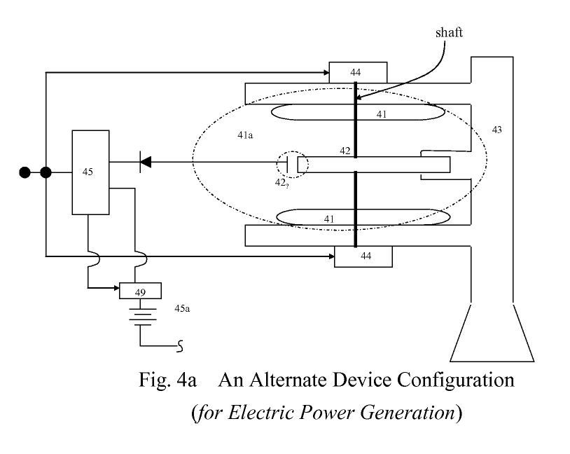

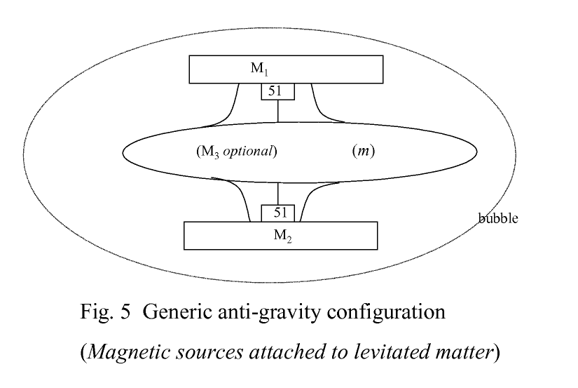

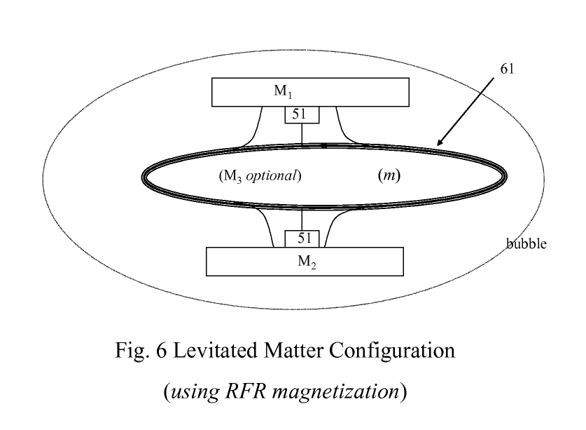

Referencing FIG. 4, a device configuration (suitable for laboratory-scale usage, or full size applications) is illustrated. The purposes of this device are production of electric energy and production of anti-gravity conditions. The device can be used to demonstrate SCR, to refine methods of attaining SCR, and to examine SCR related conditions. The device can be implemented on the laboratory-scale, or up-scaled for real applications. The device consists of two magnetic sources 41, which can be implemented as magnetic disks or as arrays of electromagnetic elements. The two control mechanisms 44, are each used to control one of the magnetic sources. If a magnetic source 41 is implemented as a simple magnetic disk, its control mechanism 44 can be a simple rotary motor. In this case, the magnetic source 41, and control mechanism 44, can be connected by a simple shaft, as indicated by the dark vertical line between device-components 41 and 44. If a magnetic source 41 is implemented as an array of electromagnetic elements, its control mechanism 44 controls the activation/deactivation sequence and field strength of the array elements. This element activation/deactivation sequence is such as to generate a “virtual rotation” of the magnetic source 41. A single device could employ both types of implementation, depending on application and operational requirements.

The dielectric material 42 is used in the process of electric energy generation. The electric energy is generated by dynamics of the magnetic field, produced by the counter-rotating magnetic sources 41, interacting with the dielectric material 42. This process is defined in [18] and [25]. The dielectric material 42 is removed from the stand 43, when generation of anti-gravity effects is desired. The area 41a, between the magnetic sources becomes an anti-gravity “bubble”, wherein anti-gravity effects can be examined and utilized. Such is a basis of an electric power generation concept of zero-gravity MHD power generation, wherein an MHD process is conducted within the “bubble”, produced by a large application-scale embodiment of the device.

The control circuit 45, and its initialization battery power subsystem 45a, is used to control the electric energy feed, from the device when the electric power generation application is in operation. The electric power is distributed to the motors 44. It is important to note that the device of FIG. 4 is obviously not an “over unity” device. It is however, an efficient, multi-purpose system that (for some applications) can generate some of its own power, after initial startup.

Regarding FIG. 4a, an alternative configuration primarily for electric power generation is shown. The magnetic sources 41 remain stationary, while the dielectric material 42 is rotated. The dielectric is implemented as a flywheel type device. The motors 44 are used to spin/rotate the flywheel 42. A capacitor type arrangement 42, is used to extract resulting energy. The energy generation basic process is defined in [18]. The anti-gravity effect will increase the efficiency of the flywheel rotation. The dielectric material 42, could be properly magnetized, for advanced applications.

Regarding FIG. 5, an example configuration of the magnetic field produced around the vehicle by sources M₁ and M₂ is shown. This electromagnetic “bubble” is the mechanism that induces local spacetime curvature, and the resultant geodesic, along which the ship (s) falls. This electromagnetic “bubble” also provides radiation protection for the ship. Depending on the configuration of M₁ and the configuration of M₂, the shape/configuration of the “bubble” can be altered. For example, if M₁ and/or M₂ is a grid/array of individual electromagnets, the field configuration could be altered (as required) for a desired structure of the magnetic field “bubble” surrounding the ship. This could be used to control the desired direction and magnitude of [symbol] As a control & navigation method, the elements of the array [M₁, M₂] could be treated as components of a Ricci Tensor defining the local neighborhood of the vehicle.

By manipulation of the components/array-elements, the configuration of array [M₁, M₂] can be controlled, and thus the relative configuration of M₁ and M₂ can be controlled, thus controlling [symbol] magnitude & direction, and minimizing the electromagnetic forces interior to the levitated matter; Such minimization could be optimized (to full neutralization) by magnetization of the levitated matter or by a third magnet M₃, attached to the levitated matter. Considering the fact that circular-polarized electromagnetic radiation can magnetize matter [6, 21, 22], magnetization of the matter to be levitated can take place. The magnetization process can range from a laser beam through a circularly polarizing lens [21], to the use of a radio frequency generator device, to produce Radiatively-induced Fermion Resonance (RFR). The RFR process results in magnetization of the material/matter impacted by the radio-wave energy. The radio frequency sources could eventually be off-the-shelf devices, greatly reducing cost & weight;

Regarding FIG. 6, the configuration of FIG. 5 is again shown, wherein the rotary motors are replaced by radio frequency projectors to magnetize the material/matter of M₁ and M₂ to induce magnetization via an RFR process. Thus, permanent magnets don't have to be used for the M₁ and/or M₂ magnetic sources. Counter-rotation, of the magnetic sources, could be achieved by rotating the radio-frequency projectors in such manner as to sequentially magnetize sections of the material of M₁ and/or M₂ thus avoiding the need to physically rotate germinate magnets. This could have significant operational advantages, especially for large scale applications.

It is expected that the present invention and many of its attendant advantages will be understood from the forgoing description and it will be apparent that various changes may be made in form, implementation, and arrangement of the components, systems, and subsystems thereof without departing from the spirit and scope of the invention or sacrificing all of its material advantages, the forms hereinbefore described being merely preferred or exemplary embodiments thereof.

The foregoing description of the preferred embodiment of the invention has been presented to illustrate the principles of the invention and not to limit the particular embodiment illustrated. It is intended that the scope of the invention be defined by all of the embodiments encompassed within the following claims and their equivalents.

1. A method for inducing spacetime curvature in a region between magnetic sources, by counter-rotating said magnetic sources, relative to each other, in such manner as to affect matter in said region to levitate in a way similar to the way said matter would behave in a gravity-neutral environment, whereby the region between the magnetic sources can be interpreted as a gravity-neutral region, whereby gravitation is a manifestation of spacetime curvature.

2. The method of claim 1, wherein said magnetic sources are connected/attached to the matter between them, in such manner as to cause said matter to behave in a levitated state, in the way said matter would behave in a gravity-neutral environment.

3. The method of claim 1, wherein said magnetic sources are configured in such manner as to induce spacetime curvature in a specific direction, such that said matter responds to said induced spacetime curvature, by moving/falling along the geodesic curve defining the direction of said induced spacetime curvature, whereby said induced spacetime curvature is defined as a geodesic curve, which defines the response in a specific direction of matter to spacetime curvature.

4. A system for inducing spacetime curvature in a region between magnetic sources, by counter-rotating said magnetic sources, relative to each other, in such manner as to affect matter in said region to levitate in a way similar to the way said matter would behave in a gravity-neutral environment, whereby the region between the magnetic sources can be interpreted as a gravity-neutral region, whereby gravitation is a manifestation of spacetime curvature.

5. The system of claim 4, wherein said magnetic sources are connected/attached to the matter between them, in such manner as to cause said matter to behave in a levitated state, in the way said matter would behave in a gravity-neutral environment.

6. The system of claim 4, wherein said magnetic sources are configured in such manner as to induce spacetime curvature in a specific direction, such that said matter responds to said induced spacetime curvature, by moving/falling along the geodesic-path defining the direction of said induced spacetime curvature, whereby said induced spacetime curvature is defined as a geodesic curve, which defines the response in a specific direction of matter to spacetime curvature.

7. The system of claim 4, wherein said magnetic sources are implemented by the application of circularly polarized electromagnetic radiation to magnetize non-magnetic materials from said sources, thus forming said magnetic sources, whereby the process of inducing magnetization by circularly polarized electromagnetic radiation is referred to as the Inverse Faraday Effect.

8. The system of claim 7, wherein said circularly polarized electromagnetic radiation is produced by radio frequency device technology, whereby the process of producing circularly polarized electromagnetic radiation by a radio frequency device is referred to as Radiatively induced Fermion Resonance (RFR).

9. The system of claim 4, wherein said matter is caused to rotate in the region between said magnetic sources, thus enabling counter-rotation between said matter and said magnetic sources, in such manner as to cause said matter to levitate between said magnetic sources, whereby the regions between said matter and said magnetic sources can be interpreted as gravity-neutral regions, whereby said levitation process is most efficient if said matter is magnetized.
